(19) United States
(12) Patent Application Publication
(10) Pub. No.: US 2006/0040079 A1
(43) Pub. Date: Feb. 23, 2006

(54) Method of die coating with a die coater

(76) Inventor: Kazutoshi Sekihara, Annaka-shi (JP)

Correspondence Address: DENNISON, SCHULTZ, DOUGHERTY & MACDONALD;David E. Dougherty, Suite 105, 1727 King Street, Alexandria, VA, 22314, US

(21) Appl. No.: 11/196,392

(22) Filed: Aug. 4, 2005

(30) Foreign Application Priority Data
Aug. 20, 2004 (JP) JP2004-241448

(51) Int. Cl. B44F 1/06; B32B 29/00; B32B 27/00; B05D 3/02; B05D 3/12

(52) U.S. Cl. 428/38; 427/355; 427/372.2; 428/421; 428/532

(57) ABSTRACT

The invention provides an inexpensive improved die-coating method for the preparation of a high-quality pellicle membrane used for dust-proof protection of a photomask in the photolithographic patterning works in respect of greatly decreased deposition of foreign matter particles and increased uniformity of the film. The improvement is accomplished by a method comprising the steps of: keeping the coating die end as immersed in the coating solution; gently pulling up the coating die at a rate, for example, not exceeding 2 mm/second until the die end comes apart from the solution; and holding the coating die as pulled up until the drops of the coating solution hanging from the die end disappear by means of the surface tension of the solution giving a flat, smooth end surface of the coating die prior to the start of the coating works on a substrate surface with the coating solution ejected from the slit in the coating die end followed by drying and peeling of the resin film off the substrate surface.

### BACKGROUND OF THE INVENTION

The present invention relates to a method of die-coating with a die coater. More particularly, the invention relates to a method of die coating applicable to the preparation of a pellicle membrane for a framed pellicle which is a device used for dust-proof protection of a photomask in the photolithographic patterning works on a semiconductor silicon wafer in the manufacture of semiconductor devices or on a glass plate in the manufacture of liquid crystal display panels. When a framed pellicle is used to cover the photomask, dust particles falling from above are deposited on the pellicle membrane and not directly on the patterned photomask so that, if the exposure light beams are focused onto the photomask pattern, the accuracy of the photolithographic patterning is never affected by the dust particles deposited on the pellicle membrane by virtue of the distance kept between the pellicle membrane and the patterned photomask.

The pellicle membrane is a thin film of a thermoplastic resin such as cellulose derivatives and fluorine-containing polymers having transparency to the exposure light beams. The membrane is spread, in a slack-free fashion, over and adhesively bonded to one end surface of a frame of a rigid material such as aluminum, the other end surface of the rigid frame being coated usually with a pressure-sensitive adhesive such as polybutene resins, polyvinyl acetate resins, acrylic resins and the like in order to ensure stability of mounting of the framed pellicle on a photomask.

It is in many cases in the prior art that the plastic films used as the pellicle membrane are prepared by the so-called spin-coating method in view of the good accuracy and good reproducibility of the film thickness and little contamination with foreign matter particles in the course of preparation in addition to the advantage of relatively low manufacturing costs.

Along with the recent progress in the photolithographic patterning technology to be in compliance with the starting prevalence of large-sized liquid-crystal display panels and the multiple patterning technology on a single semiconductor wafer, pellicles are also required to be larger and larger with pellicle membranes of a correspondingly increased spread. As the dimensions of the pellicle membrane are increased larger and larger in size, the aforementioned spin coating method is no longer applicable to the preparation of the films due to several problems including a relatively large consumption of the film material necessarily leading to an increased manufacturing cost.

As compared with the spin coating method, the so-called die coating method, known per se in the prior art, by using a die coater, which may sometimes be called a curtain-flow coater, slit coater, slit die coater or the like, has several advantages in respects of the decreased futile loss of the coating material as in the spin-coating method and applicability to large-sized color displays for liquid crystal display panels and plasma-display panels as well as color filters used in the solid-state image pickup elements, resists and the like. Thus, it would be a unique idea to apply the die coating method to the preparation of a plastic resin film used as a pellicle membrane of a framed pellicle for photomask protection.

In conducting the die coating by using a die coater, it is necessary before start of the coating work to effect initial conditioning of the die end by removing drops of the coating solution hanging from the die end. If the drops remain unremoved, collapsing of beads formation is caused resulting in occurrence of streaks and unevenness in the films produced. Accordingly, various proposals have been made heretofore for initial conditioning of the die end before conducting the die coating works. For example, FIG. 8 illustrates an example of such proposals, in which the lip portion of the die nozzle 81 is brought, immediately before application of the coating solution, into direct contact with the cleaner member 83 having a surface layer of a polymeric resin with rubbery elasticity and having a configuration of the upper surface to be capable of direct contacting with the lip portion of the die nozzle and then the cleaner member is moved by means of the driving mechanisms 84 along the lip portion of the die nozzle so as to scrape down the coating solution 82 (see Japanese Patent No. 3306838).

Alternatively, a scraper blade made of a plate of a hard rubber or a plastic resin is brought into contact with the lip portion of the die body and the coating solution adhering to the lip portion is removed by scraping with the scraper blade moved along the lip portion (see Japanese Patent Kokai 11-147062).

A problem in these methods, however, is that, in the presence of a large amount of adhering foreign matters, the cleaner member or the scraper blade must be moved under press-contacting with a certain pressing force against the lip portion in order to ensure complete removal of the liquid drops. In such a scraping condition, it is more or less unavoidable that the surface of the scraping means is shaved off by contacting with the die resulting in incomplete scraping therewith leaving some foreign matters unremoved on the die end. This means that the foreign matters falling from the scraping means are deposited spot-wise onto the films produced therewith rendering the film product unacceptable.

Further alternatively, a non-contacting conditioning of the die end is proposed (see Japanese Patent Kokai 2001-310147) in which a preparatory ejection of the coating solution is conducted onto a roll-formed body as a target so that the die end can be conditioned. In this method, it might be possible to obtain a film product free from deposition of foreign matters because the die end is never contacted with the scraping means. Actually, however, it is a difficult matter to effect complete removal of foreign matter particles with the relatively low foreign matter removing force unless the ejection procedure with the roll-formed target body is repeated frequently because the inherent object of this method is to condition the bead end.

Accordingly, the extent of contamination of the product films by foreign matter deposition entirely depends on some chances and it is sometimes the case that deposition of foreign matters continues for a length of time if the die end is contaminated by touching in conducting maintenance works or the like.

Even if the roll-formed body as a target of the preparatory ejection of the coating solution is cleaned and regenerated each time after the initial conditioning of the die end by removing the foreign matters and the coating material remaining on the surface of the roll-formed body, the removal can never be complete so that redeposition of solid particles from the roll-formed body is sometimes unavoidable. In a long-run use of the coating die, moreover, dried debris of the coating solution and other solid matters, which are hardly removed by the initial conditioning treatment of the die end, adhere to and around the ejection slit and fall down from time to time to cause contamination of the film products as a foreign matter.

In the die coating method by using a die coater, the conclusion from the above is that no satisfactory process has yet been established to effect initial conditioning of the die end to be freed from deposition of any foreign matters so that it is a difficult matter to obtain a coating film having an extremely small number of foreign materials so that the method of die coating is considered to be little promising for the purpose and the method of spin coating is deemed to be the only practical means at low costs for the preparation of plastic resin films used for pellicle membranes.

### SUMMARY OF THE INVENTION

Thus, it is an object of the present invention, in view of the above described situations of the art, to provide an inexpensive plastic resin film suitable for use as a pellicle membrane of a large-size framed pellicle with an extremely decreased number of foreign matter particles deposited on the film by establishing the maneuver for maintenance and management of the coating die in the die coater enabling a great decrease in the foreign matter particles deposited on the film.

Thus, the present invention provides an improvement which comprises, in a die coating method for the preparation of a plastic resin film for use in a framed pellicle by coating a flat surface of a substrate with a resin-containing coating solution ejected from a slit at the lower end of a coating die to be uniformly spread over the substrate surface followed by drying, the steps of:
(a) keeping the lower end of the coating die in contact with the surface of or as immersed in the coating solution contained in a vessel;
(b) gently pulling up the coating die until the lower end of the die has come to completely leave the surface of the coating solution;
(c) holding the coating die as pulled up until the drops of the coating solution hanging from the die surface disappear by flattening with the surface tension of the solution; and
(d) ejecting the coating solution from the slit of the coating die onto the surface of a substrate for coating.

In particular, it is preferable that the rate of pulling up of the coating die in step (b) above does not exceed 2 mm/second. It is further preferable in order to ensure a clean condition of the die end in step (a) by continuously or intermittently ejecting the coating solution freed from solid particles by passing a filter from the die end or by subjecting the die end in step (a) to ultrasonic cleaning or by subjecting the die immersed in the coating solution in step (a) to scrub cleaning with an elastic cleaner body.

It is optional that the coating die after step (c) is subjected to a preparatory ejection of the coating solution onto a flat body or a rotating roll-formed body as a target for the run of film preparation.

Though not particularly limitative, the above described die coating method yields a quite satisfactory result by using a cellulose derivative or a fluorine-containing polymer as the plastic resin dissolved in the coating solution when the desired product of the method is a resin film used as a pellicle membranes.

### BRIEF DESCRIPTION OF THE DRAWING

FIG. 1 is a schematic perspective view illustrating the principle of the die-coating method.

FIGS. 2A, 2B and 2C are each a schematic cross sectional view illustrating an embodiment of the inventive method.

FIG. 3 is a schematic diagram illustrating a piping system in an embodiment of the inventive method.

FIGS. 4A and 4B are each a schematic cross sectional view illustrating an embodiment of the inventive method involving the step of cleaning of the die end.

FIG. 5 is a schematic cross sectional view illustrating an embodiment of the inventive method involving the step of preparatory ejection of the coating solution.

FIG. 6 is a schematic perspective view illustrating the basic arrangement of the die coater used in conducting the inventive method.

FIG. 7 is a schematic perspective view of a framed pellicle used for photomask protection in photolithographic patterning.

FIG. 8 is a schematic cross sectional view illustrating the principle of prior art for conditioning of the coating die end.

### DETAILED DESCRIPTION OF THE PREFERRED EMBODIMENTS

In the following, the method of the present invention is described in more detail by making reference to the accompanying drawing, of which each of the Figures is briefly described above.

As is illustrated in FIG. 1 illustrating the principle of the die coating method with a die coater, a curtain flow of the coating solution introduced from an inlet 13 is ejected out of the precision-worked narrow slit of the coating die 11 onto the surface of a flat plate 12 as a substrate for coating while the plate 12 is horizontally moved at a constant velocity by means of a precision driving means (not shown in the figure) so that a layer 14 of the coating solution having a uniform thickness is formed on the plate 12.

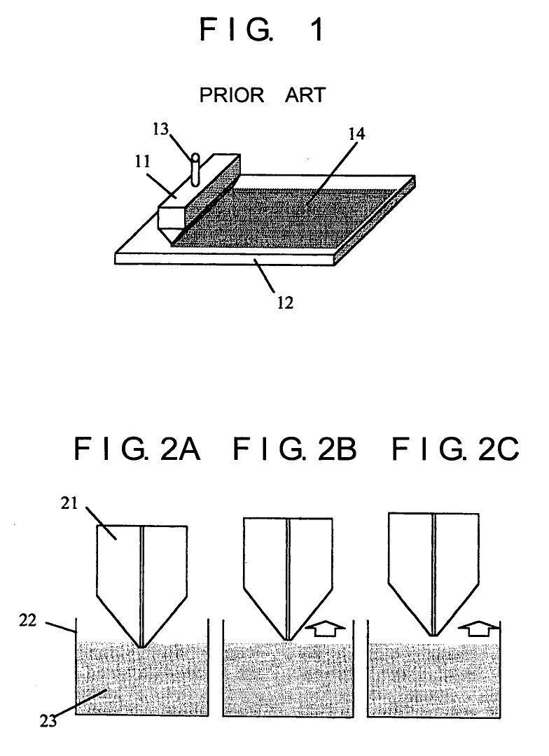

As is illustrated in FIG. 2A, which describes an embodiment of the inventive method, the end portion of the die 21 kept immersed in the coating solution 23 filling the die-drying inhibitor pan 22 is gently puller up. When the pulling-up velocity of the die at least at the moment when the lower end of the die 21 just leaves the surface of the coating solution in the pan is sufficiently small, the liquid drops hanging down from the lower end of the die are pulled downwardly toward the surface of the coating solution in the pan 22 by the surface tension as is shown in FIG. 2B leading to complete transfer of all of the liquid drops into the body of the coating solution in the pan 22 as is illustrated in FIG. 2C. Thus, formation of a uniform coating film of the coating solution on the substrate surface can be accomplished usually with the die end free from hanging liquid drops of the coating solution.

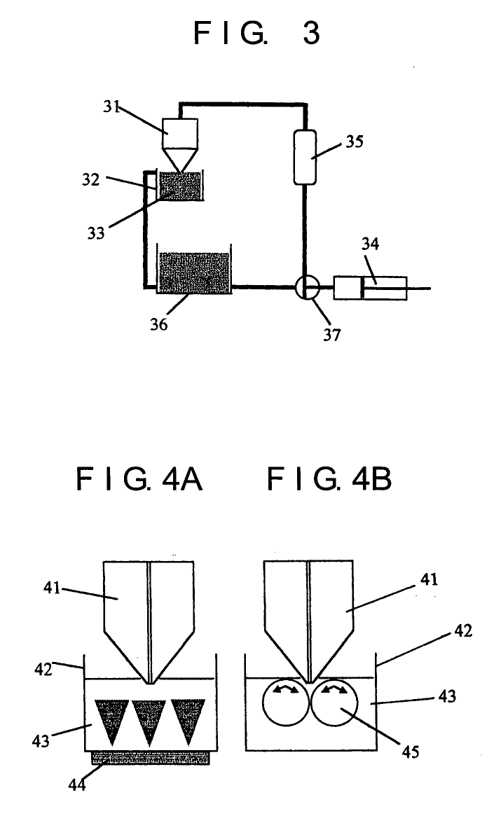

Since, as is illustrated above, the die end in the inventive method comes into contact with nothing other than the coating solution in the pan 22, the die end is always kept clean without being contaminated with foreign materials deposited thereon. It is preferable that the pulling-up velocity of the die end at a moment when the die end just leaves the coating solution in the pan 22 does not exceed 2 mm/second in order to ensure full and complete removal of the liquid drops from the die end although this limiting velocity should not be construed as critical but depends on the viscosity and other physical properties of the coating solution and can be selected adequately. In an event of particular importance of decreasing the overall working time for a run of film preparation, it is optional that the pulling-up velocity of the die is adjusted to be considerably higher than 2 mm/second until the die end reaches the very vicinity of the surface of the coating solution and then the velocity is slowed down to 2 mm/second or lower just before the leaving moment of the die end. In the embodiment illustrated in FIG. 4A, an ultrasonic vibrator board 44 is attached to the bottom of the pan 42 so that the die end is under an ultrasonic cleaning effect via the solution 43. The frequency of the ultrasonic vibration is preferably in the range from 30 to 100 kHz, though not particularly limitative. This ultrasonic cleaning method serves as a precision cleaning of the die end because no solid cleaner body is contacted with the die. In the embodiment illustrated in FIG. 4B, the end of the die 41 immersed in the coating solution 42 is subjected to a scrub cleaning action with a pair of scrubbing rollers 45 made from an elastic material.

In the ultrasonic embodiment illustrated in FIG. 4A, the intensity and frequency of the ultrasonic vibrations should be selected adequately depending on the properties of the coating solution but it is important to select these parameters not to cause the phenomenon of cavitation which forms tiny bubbles in the coating solution adversely affecting the coating works and the product quality.

The scrub cleaning method of the embodiment illustrated in FIG. 4B is particularly suitable when the die end is so heavily contaminated or the coating solution is liable to cause cavitation or bubble formation. Needless to say, it is essential that the material forming the scrubber bodies and the form thereof should be selected in consideration of the types and workability of the coating solution. It is important that the scrubber body 45 is made from a rubbery elastic material which is safe against the attack of the coating solution to be free from occurrence of any dissolved matter. The amount of dust occurrence from the scrubber bodies in contact with the die 41 should desirably be as small as possible. In addition, the rubbery material for the scrubber bodies must have good precision workability enabling formation of a scrubber body leaving no gap spaces around the die end.

In the embodiment of the scrub cleaning method illustrated in FIG. 4B, the scrubber body is, though not limitative, in the form of a rotatable roller but can be any other forms provided that the scrubber body just fits the die end. For example, the scrubber body can be in the form of a sheath made of plates to be applied to and moved along the surface of the die in the length-wise direction. The cleaning method illustrated in FIG. 4A or 4B can be undertaken as incorporated into the piping system illustrated in FIG. 3 for circulation of the coating solution.

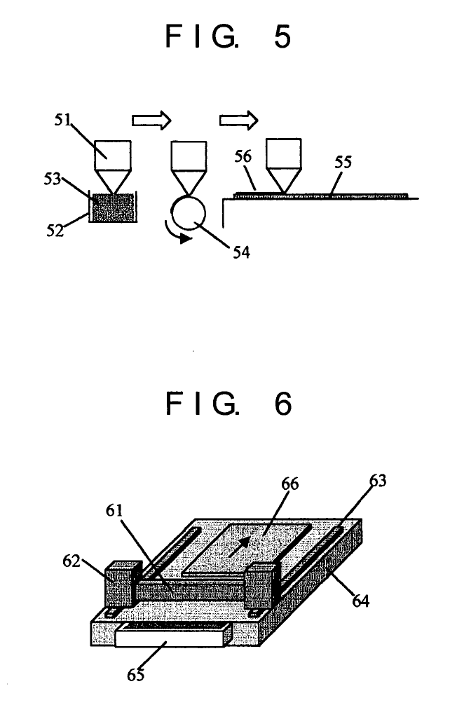

FIG. 5 illustrates a further different embodiment of the inventive method for subjecting the die end to initial conditioning in which the die end is contacted with a rotating roller and the like during the preparatory ejection of the coating solution. In the case of a rapidly drying coating solution, it is sometimes the case that the die end becomes dried up after removal of liquid drops therefrom leading to occurrence of streaks. The embodiment of FIG. 5 is particularly useful in such a case. Namely, the die 51 is pulled up above the coating solution 53 and subjected to a drop-removing movement followed by preparatory ejection of the solution at a roller 54 rotating at an appropriate velocity and the coating work is immediately started. Needless to say, the target body of the preparatory ejection is not limited to a rotating roller but can be a flat plate with which an equivalent effect can be expected.

Along with immersion of the end of the die 31 in the coating solution to prevent drying up, it is further advantageous that the coating solution after filtration through a filter unit 35 is constantly ejected out of the die end so that formation of a gelled matter within the die can be prevented. The outflow of the coating solution through the die end is interrupted immediately before start of the coating work followed by the drop-removing movement of the die as is shown in FIG. 2 so that the deposition-preventing effect against foreign materials can be more reliable.

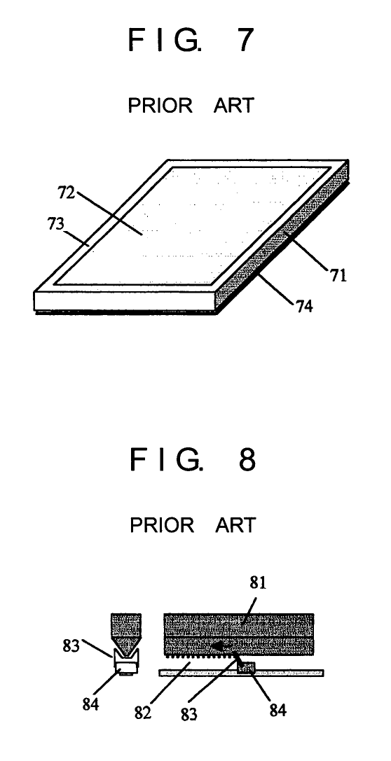

Following is a description of the process for the preparation of a framed pellicle by applying the coating method by use of the above described die coater making reference to FIGS. 6 and 7. In the first place, a pellicle membrane is prepared by utilizing the coating method of using the above described die coater. As is illustrated in FIG. 6, a substrate 66 fixedly mounted on a level block 64 is coated with the coating solution by means of the coating die 61 which is supported by a vertical die-driving mechanism 62 and guided by a linear stage mechanism capable of driving the coating die in the direction of coating. The height level of the die is automatically adjusted by means of a control system provided in the vertical driving mechanism 62 depending on the height level of the substrate 66 having the two ends on the level block 64 for coating. The level block 64 has, at one end, a die-drying inhibitor pan 65. Though not shown in this figure, the die end can be kept immersed in the coating solution contained in the die-drying inhibitor pan 65 by means of a suitable mechanism for vertical movement. The resin film thus formed on the substrate 66 is, after drying, peeled off from the substrate to give an unsupported film which serves as a pellicle membrane having a very small amount of foreign matter particles deposited thereon. As is illustrated in FIG. 7, the pellicle membrane 72 is spread over and adhesively bonded to a rigid pellicle frame 71 in a slack-free fashion with intervention of a bonding adhesive layer 73 to give a framed pellicle of any size at low costs.

The above described method for the preparation of a framed pellicle is widely applicable to the preparation of framed pellicles for glass panels in liquid crystal displays and PDPs, glass filters used in solid-state picture-pickup tubes and the like where uniform large-width resin films free from deposition of foreign particles are required.

### EXAMPLE 1

In the following, the method of the present invention is described in more detail by way of an Example which, however, never limits the scope of the invention in any way. The die coater used in this Example was a combination of the device illustrated in FIG. 6 and the piping system illustrated in FIG. 3 with addition of the ultrasonic vibration board illustrated in FIG. 4. The die 61 made of a SUS304 grade stainless steel and the die end had a coating width of 796 mm and the die end slit thereof had a width of 0.3 mm. The coating solution was a 9% by mass solution of a fluorocarbon polymer (Cytop, a product by Asahi Glass Co.) dissolved in a fluorine-based solvent therefor (CT-Solve, a product by Asahi Glass Co.). The substrate for coating was a plate of synthetic quartz glass having dimensions of 800 mm by 920mm by 8 mm thickness and was flatly polished on both surfaces. All of the apparatuses were installed in a clean room of Class 10 cleanness.

In the above described arrangement of the apparatuses, the end of die 61 kept immersed in the coating solution contained in the die-drying inhibitor pan 65 was subjected to ultrasonic irradiation at a frequency of 40 kHz for 5 minutes preceeding start of the coating work and then kept standing for additional 5 minutes under ejection of the coating solution followed by interruption of ejection of the coating solution into the pan 65. The ejection rate of the coating solution was 50 ml/minute. Thereafter, as is shown in FIGS. 2A to 2C, the die was gently pulled up at a velocity of 0.1 mm/second. Immediately after confirmation of complete disappearance of the liquid drops from the die end, the die 61 was transferred to above the coating position of the substrate 66 to start coating of the substrate at a speed of 10 mm/second.

When the coating work carried out in the above described manner had come to completion, the thus coated substrate was transferred to a drying room and subjected to removal of the solvent from the coating layer by heating at 180° C. for 5 minutes to give a resin film having a thickness of 4.0 μm. The substrate bearing the resin film formed thereon was subjected to careful visual inspection in a dark room under an aslant illumination with a focusing lamp of 400000 lux illuminance to find absolutely no deposition of foreign matter particles on the resin film. A rectangular adhesion frame (not shown in the figure) having approximately equivalent dimensions to the resin film made from an aluminum alloy was put onto and adhesively bonded to the resin film followed by separation of the resin film from the substrate to obtain a pellicle membrane. A rectangular pellicle frame of an aluminum alloy machine-worked to have outer dimensions of 750 mm by 904 mm by 6.5 mm height and inner dimensions of 734 mm by 890.5 mm and surface-anodized in black was coated on one end surface with a silicone-based pressure-sensitive adhesive (KR 120, a product by Shin-Etsu Chemical Co.) and the above obtained resin film was spread over and bonded to the pellicle frame in a slack-free fashion followed by trimming of the resin film along the outer surface of the frame by using a cutter blade to complete a framed pellicle. The thus completed framed pellicle was subjected to visual inspection in a clean room under illumination with a 400000 lux halogen lamp on a 734 mm by 890.5 mm area of the membrane to detect only 8 particles of foreign matters having a diameter not exceeding 1 μm in support of the conclusion that the framed pellicle prepared by the inventive method was extremely clean in addition to the absolute absence of defects in appearance such as streaks, uneven discoloration and the like.

### Comparative Example 1

The die coater used in this Comparative Example was of the same type as used in the above-described Example 1 except that the die-drying inhibitor pan was replaced with a die-end conditioning mechanism of the type illustrated in FIG. 8, in which the cleaning member made from a polyethylene sheet of 500 μm thickness was worked to have an inclination of 15 degrees. In the first place, about 50 ml portion of the coating solution was ejected out of the end of the die 81 with an object of initial cleaning followed by removal of the coating solution 82 adhering to the die 81 by scraping. Immediately thereafter, the die 81 was moved to above the substrate to start coating. The substrate for coating, formulation of the coating solution and the conditions of the coating works were each exactly the same as in Example 1 described above.

The substrate bearing the coating layer of the coating solution was heated at 180° C. for 5 minutes to remove the solvent from the coating layer giving a dried resin film having a thickness of 4.0 μm as dried. The substrate bearing the thus dried coating film was subjected to visual inspection in a dark room under aslant illumination with a focusing lamp of 400000 lux illuminance to detect numberless foreign particles having an estimated particle diameter of 200 μm at the largest on allover the substrate surface in a distribution density of 30 to 50 particles per 100 mm by 100 mm area. Due to this surface condition, the resin film was found to be unacceptable for the application as a pellicle membrane in the photolithographic patterning works.

As is clear from the above description, the present invention provides an inexpensive die coating method for the preparation of a resin film suitable for use as a pellicle membrane in the photolithographic patterning works due to an outstandingly small number of foreign matter particles deposited on the film as a result of a simple means for cleaning or initial conditioning of the die end. Accordingly, the present invention is industrially very valuable in order to comply with the recent trend requiring larger and larger framed pellicles.

What is claimed is:

1. In a die coating method for the preparation of a resin film for use as a pellicle membrane in a framed pellicle by coating a flat surface of a substrate with a resin-containing coating solution ejected from a slit in the lower end of a coating die to be uniformly spread over the substrate surface followed by drying, an improvement which comprises the steps of:
(a) keeping the lower end of the coating die as immersed in the coating solution or in contact with the surface of the coating solution;
(b) gently pulling up the coating die until the lower end of the coating die has come to completely leave the surface of the coating solution;
(c) holding the coating die as pulled up above the coating solution until the drops of the coating solution hanging from the lower end of the coating die disappear by virtue of the surface tension of the coating solution so that the lower end of the coating die has a flat surface wet with the coating solution; and
(d) bringing the coating die to above the substrate for coating to start coating with the coating solution ejected from the slit in the lower end of the coating die.

2. The improvement as claimed in claim 1 in which the velocity of pulling up of the coating die in step (b) does not exceed 2 mm/second.

3. The improvement as claimed in claim 1 in which, in step (a), the coating solution is continuously or intermittently ejected from the slit in the lower end of the coating die kept immersed in or in contact with the surface of the coating solution, the coating solution for ejection being freed from foreign matter particles by filtration through a filter member.

4. The improvement as claimed in claim 1 in which, in step (a), the lower end of the coating die immersed in the coating solution is irradiated with ultrasonic waves to effect cleaning.

5. The improvement as claimed in claim 1 in which, in step (a), the lower end of the coating die immersed in the coating solution is subjected to scrub cleaning with an elastic body.

6. The improvement as claimed in claim 1 in which step (b) is followed by a preparatory ejection of the coating solution from the slit in the lower end of the coating die, the ejection of the coating solution being directed at a flat plane or at a rotating roller-formed body as a target surface.

7. A framed pellicle for dust-proof protection of a photomask in photolithograpphic patterning works prepared by adhesively bonding a pellicle membrane, which is a resin film formed in accordance with claim 1 and separated from the substrate by peeling off the substrate, to one end surface of a frame of a rigid material in a slack-free fashion with intervention of an adhesive layer.

8. The framed pellicle as claimed in claim 7 in which the pellicle membran is formed from a resin selected from the group consisting of cellulose derivatives and fluorine-containing polymers.
